(19) United States
(12) Patent Application Publication
(10) Pub. No.: US 2018/0255367 A1
(43) Pub. Date: Sep. 6, 2018

(54) METHOD AND DEVICE FOR IMPLEMENTING A VIDEO APPLICATION

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Yuanhang REN, BEIJING (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/120,156

(22) PCT Filed: May 27, 2016
(86) PCT No.: PCT/CN2016/083728

§ 371 Date: Aug. 19, 2016

(30) Foreign Application Priority Data
Nov. 25, 2015 (CN) 201510835479.5

(51) Int. Cl. H04N 21/485; G09G 5/10; G06F 17/30

(52) U.S. Cl. CPC H04N 21/4854; G09G 2320/0626; G06F 17/3084; G09G 5/10

(57) ABSTRACT

Disclosed is a method and device for implementing a video application, the method including the steps of acquiring an instruction of clicking on a video search page in the video application; monitoring the light intensity before screen within a predetermined time and calculating the brightness value of the video search page based on the average light intensity within the predetermined time; and setting the brightness value of the video search page and displaying the video search page based on the obtained brightness value. Therefore, the method and device for implementing a video application overcome the problem of a dazzling feeling and discomfort for users when they open the video application and search in a video search page.

### CROSS-REFERENCE TO RELATED APPLICATIONS

This application is a continuation of International Application No. PCT/CN2016/083728, filed on May 27, 2016, which is based upon and claims priority to Chinese Patent Application No. 2015108354795, filed on Nov. 25, 2015, the entire contents of all of which are incorporated herein by reference.

### TECHNICAL FIELD

The present disclosure relates to media communication technology, in particular to method and device for implementing a video application.

### BACKGROUND

With rapid development of multimedia technology, video application technology is used by more and more users. Now, it is an important recreation for watching videos in people's spare time, whether at home or during the travel by vehicle or on other occasions, people can watch the videos by terminal devices.

In the prior art, when a user opens the video application by using the terminal device, during the search process in the video search page, it is often occurred that the over-strong brightness of the video file search page at night causes a dazzling feeling and discomfort for the user.

### SUMMARY

For this purpose, an object of the application is to propose methods and apparatus for implementing a video application to overcome the problem of a dazzling feeling and discomfort for users when they open the video application and search in a video search page.

The embodiment of the present disclosure provides a method for implementing a video application to achieve the object, including:

acquiring an instruction of clicking on a video search page in the video application;

monitoring the light intensity before screen within a predetermined time, and calculating the brightness value of the video search page based on the average light intensity within the predetermined time; and

setting the brightness value of the video search page based on the obtained brightness value and displaying the video search page.

Alternatively, after setting the brightness value of the video search page and displaying the video search page, the method further includes:

obtaining a background color value of the video search page and extracting a text and image color value of the video search page; and

determining whether the difference between the text and image color value and the background color value exceeds a predetermined similarity threshold; in accordance with the result of the determination, maintaining the background color value unchanged or adjusting the background color value so that the difference between the text and image color value and the background color value exceeds the predetermined similarity threshold.

Alternatively, after setting the brightness value of the video search page and displaying the video search page, the method further includes: acquiring an instruction of clicking on a video file in the video search page, and jumping to the playback page of the video file;

extracting a brightness value of a playback area in the playback page of the video file; and

setting the brightness value of the area other than the playback area in the playback page of the video file and displaying the area other than the playback area in the playback page of the video file, based on the brightness value of the playback area.

Alternatively, the method also includes: during the playback of the video file, monitoring the brightness value of the playback area in the playback page of the video file within a predetermined time; and calculating the brightness value of the area other than the playback area in the playback page of the video file, based on the average brightness value of the playback area within the predetermined time; and

setting the brightness value of the area other than the playback area in the playback page of the video file and displaying the area other than the playback area in the playback page of the video file, based on the brightness value obtained by the calculation.

Alternatively, after setting the brightness value of the area other than the playback area in the playback page of the video file and displaying the area other than the playback area in the playback page of the video file, the method further includes:

obtaining a background color value of the area other than the playback area of the playback page of the video file, and extracting a text and image color value of the area other than the playback area in the playback page of the video file;

determining if the difference between the text and image color value and the background color value exceeds the predetermined similarity threshold; and based on the result of the determination, maintaining the background color value unchanged or adjusting the background color value so that the difference between the text and image color value and the background color value exceeds the predetermined similarity threshold.

Alternatively, the method also includes: during the playback of the video file, monitoring the light intensity before screen;

if the detected light intensity at a moment is lower than the predetermined minimum intensity threshold, then pausing the current-playing video file and starting a screen saver;

determining whether there is an operation to a terminal device, then closing the screen saver and playing the paused video file if there is an operation to a terminal device; or continuing the screen saver if there is no operation to a terminal device;

or when searching in the video search page, monitoring the light intensity before screen;

if the detected light intensity at a moment is lower than the predetermined minimum intensity threshold, then starting the screen saver;

determining whether there is an operation to the terminal device, then closing the screen saver if there is an operation to the terminal device, or continuing the screen saver if there is no operation to the terminal device.

In a further another aspect of an embodiment of the present disclosure, there is provided a device, including:

one or more processor(s); and

a memory for storing an operating instruction;

wherein the one or more processor(s) is/are configured to acquire the operation instruction from the memory to execute:

acquiring an instruction of clicking on a video search page in the video application;

monitoring the light intensity before screen within a predetermined time, and calculating the brightness value of the video search page based on the average light intensity within the predetermined time; and

setting the brightness value of the video search page based on the obtained brightness value and displaying the video search page.

In a further another aspect of an embodiment of the present disclosure, there is provided a non-transitory computer-readable storage medium storing executable instructions that, when executed by an electronic device, cause the electronic device to:

acquire an instruction of clicking on a video search page in the video application;

monitor the light intensity before screen within a predetermined time and calculate the brightness value of the video search page based on the average light intensity within the predetermined time; and

set the brightness value of the video search page based on the obtained brightness value and display the video search page.

In a word, the methods and apparatus for implementing video application provided by the embodiments of the present disclosure can automatically adjust the brightness value when a user enters the video application and searches in the video search page at night, so as to avoid the glare of feeling without affecting the functions of the video search page, and thus greatly improve the video media service, by acquiring an instruction of clicking on a video search page in the video application; monitoring the light intensity before screen within a predetermined time and calculating the brightness value of the video search page based on the average light intensity within the predetermined time; and setting the brightness value of the video search page based on the obtained brightness value and displaying the video search page.

It should be understood that both the descriptions in general and in detailed are exemplary and explanatory without any limit to the present disclosure.

### BRIEF DESCRIPTION OF DRAWINGS

In order to more clearly illustrate the embodiments of the present disclosure, the drawings as required for illustrating the embodiments will be described in brief. Apparently, the drawings described below are merely some embodiments of the present disclosure, and for the ordinary skilled in the art can learn from the drawings without creative efforts.

FIG. 1 is a schematic flow diagram of a method for implementing a video application according to the first embodiment of the present disclosure;

FIG. 2 is a schematic flow diagram of a method for implementing a video application according to another embodiment of the present disclosure;

FIG. 3 is a schematic view of an apparatus for implementing a video application according to an embodiment of the present disclosure.

By the above drawings, the embodiments of the present disclosure have been shown clearly and will be described hereinafter in more detail. These drawings and description are not intended in any way to limit the scopes of the disclosure, but describe the concept of the disclosure for the skilled in the art by reference to specific embodiments.

### DETAILED DESCRIPTION

The present disclosure is described more fully hereinafter with reference to the accompanying drawings so that the objects, technical solutions and advantages of the present disclosure will become more apparent.

According to the current utilization of multimedia video applications, when a user performs a search in a video search page, it is often occurred to the user of a glaring and dazzling feeling and discomfort to watch because the brightness of the video search page is always too high or too low. To solve this problem, the present disclosure started from the user's perspective and found that the user expects to experience that the multimedia video application can automatically adjust the brightness of the video search page. Thus, the idea of the present disclosure is to provide the multimedia video application with a function of triggering the monitor of light intensity before screen to be able to monitor the light intensity before screen within a predetermined time, so as to implement the brightness adjustment and display of the video search page.

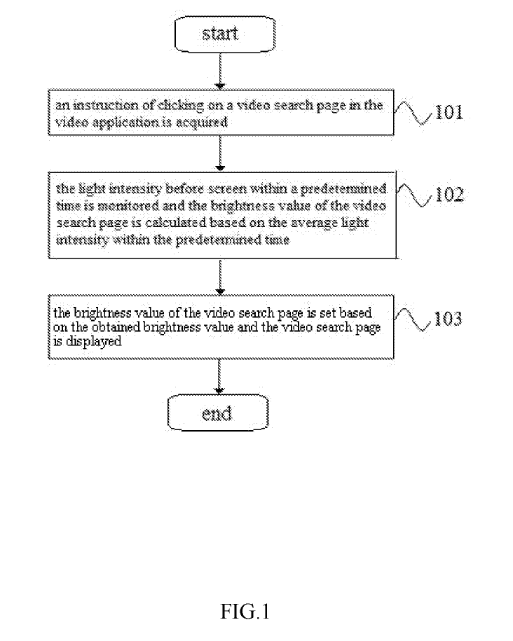

Referring to FIG. 1, a schematic flow diagram of a method for implementing a video application according to the first embodiment of the present disclosure is shown, wherein the method for implementing a video application includes the following steps.

In step 101, an instruction of clicking on a video search page in the video application is acquired.

In such step, the user can enter the video application and click on the video search page; the video application is applied in a terminal device; and the method for implementing the video application in the present disclosure can be applied into mobile phone, PC, TV and other terminal devices.

In step 102, the light intensity before screen within a predetermined time is monitored and the brightness value of the video search page is calculated based on the average light intensity within the predetermined time.

In the embodiment, after acquiring an instruction of clicking on a video search page in the video application in step 101, it will be started for monitoring the light intensity before screen within a predetermined time, wherein the predetermined time can be preset as actually required, for example, setting a predetermined time of 3 seconds; and then monitoring the light intensity before screen within a predetermined time and averaging all the detected light intensity; optionally, prior to the averaging, the highest and lowest value of the light intensity can be removed from all the detected light intensity values.

Alternatively, after obtaining the averaged light intensity, a difference between the light intensity before screen at a startup of the monitoring and the averaged value can be obtained, and the obtained difference is a varying value of the video search page. Finally, the adjusted brightness value of the video search page can be calculated based on the difference and the current brightness value of the video search page.

Instep 103, the brightness value of the video search page is set based on the obtained brightness value and the video search page is displayed.

As an embodiment, after obtaining the adjusted brightness value of the video search page in step 102, the brightness value of the video search page can be set into the adjusted value and the video search page can be displayed.

It should be noted that, after adjusting the brightness value of the video search page, it will be possible to occur that the text and images in the page are unclear, because the color value of the text and images may be close to those of the background of the video search page after the adjustment of the brightness value.

Alternatively, after setting the brightness value of the video search page and displaying in step 103, the current background color value of the video search page can be obtained and the text and image color value of the video search page can be extracted. Then, it can be determined whether the similarity between the text and image color value and the background color value exceeds a predetermined similarity threshold, if exceeding the predetermined similarity threshold, the background color value will be remained unchanged, or if not exceeding, the background color value will be adjusted so that the similarity between the text and image color value and the background color value exceeds the predetermined similarity threshold, wherein the similarity is the difference between the text and image color value and the background color value

For example, if the predetermined similarity threshold is set as 2, the obtained background color value is 15, and the extracted text color value is 16, then the difference namely similarity between the text color value and the background color value is 1 without exceeding the predetermined threshold of 2, and thus it is necessary to adjust the background color value so that the difference between the text color value and the background color value can exceed the predetermined threshold of 2. Similarly, the processing of the image color value is the same as the processing of the text color value above-mentioned, and not described herein.

It should be noted that, as an alternative embodiment of the present disclosure, monitoring the light intensity before screen can be performed during the searching in the video search page. If the detected light intensity at a moment is lower than the predetermined minimum intensity threshold, then starting a screen saver. Then it is determined whether there is an operation to a terminal device, if yes then closing the screen saver or if no then continuing the screen saver. As can be seen, this embodiment can protect the privacy of the viewer when he deliberately obscures the screen and does not want others to know the contents of the screen. Also, the screen saver can employ a way of blocking the content of video search page, such as blank screen or blocking the video search page with pictures, and so on.

As an alternative embodiment of the present disclosure, after executing step 103, the method for implementing a video application also can include the steps of acquiring an instruction of clicking on a video file in the video search page, and jumping to a playback page of the video file; extracting a brightness value of the playback area in the playback page of the video file; and setting the brightness value of the area other than the playback area in the playback page of the video file and displaying the area other than the playback area in the playback page of the video file, based on the brightness value of the playback area. That is, the brightness of the area other than the playback area in the video playback page can be set as the same as the brightness value of the playback area.

As another embodiment, the present disclosure includes the steps of monitoring the brightness value of the playback area in the playback page of the video file within a predetermined time during the playback of the video file; and calculating the brightness value of the area in the playback page of the video file other than the playback area, based on the average brightness value of the playback area within the predetermined time; and setting the brightness value of the area other than the playback area in the playback page of the video file and displaying the area other than the playback area in the playback page of the video file, based on the brightness value obtained by calculation. That is, during the playback of the video file in the video playback page, the brightness value of the area other than the playback area can be dynamically adjusted based on the brightness value of the playback area, so as to keep the brightness value of the playback area consistent with that of the area other than the playback area. Therefore, such embodiment cannot only ensure to protect the viewer from the glare and unclear when watching video, but also effectively protect the viewer's eyes and improve his comfort during the viewer watches video in the video playback page, because the brightness value of the area other than the playback area is always dynamically kept consistent with the brightness value of the playback area.

Alternatively, of course, the method further can include the steps of obtaining a background color value of the area other than the playback area of the playback page of the video file, and extracting a text and image color value of the area other than the playback area in the playback page of the video file; determining if the difference between the text and image color value and the background color value exceeds the predetermined similarity threshold, and based on the result of the determination, maintaining the background color value unchanged or adjusting the background color value so that the difference between the text and image color value and the background color value exceeds the predetermined similarity threshold. Thus, it makes the text and images of the area other than the video playback page also can be watched very clearly after adjusting the brightness value of the area other than the playback area of the playback page of the video file.

Also, it should be noted that, as a preferred embodiment of the present disclosure, the method further includes the steps of monitoring the light intensity before screen during the playback of the video file; if the detected light intensity at a moment is lower than the predetermined minimum intensity threshold, then pausing the current-playing video file and to starting a screen saver; determining whether there is an operation to a terminal device, then closing the screen saver and playing the paused video file if there is an operation to a terminal device; or continuing the screen saver if there is an operation to a terminal device. As can be seen, this embodiment can ensure the hidden of the video playback page and protect the privacy of the viewer when he/she deliberately obscures the screen and does not want others to know the contents of the screen, so as to achieve the innovative function when the video application provides services for users. Also, the screen saver can employ a way of blocking the content of video playback page, such as blank screen or blocking the video search page with pictures, and so on.

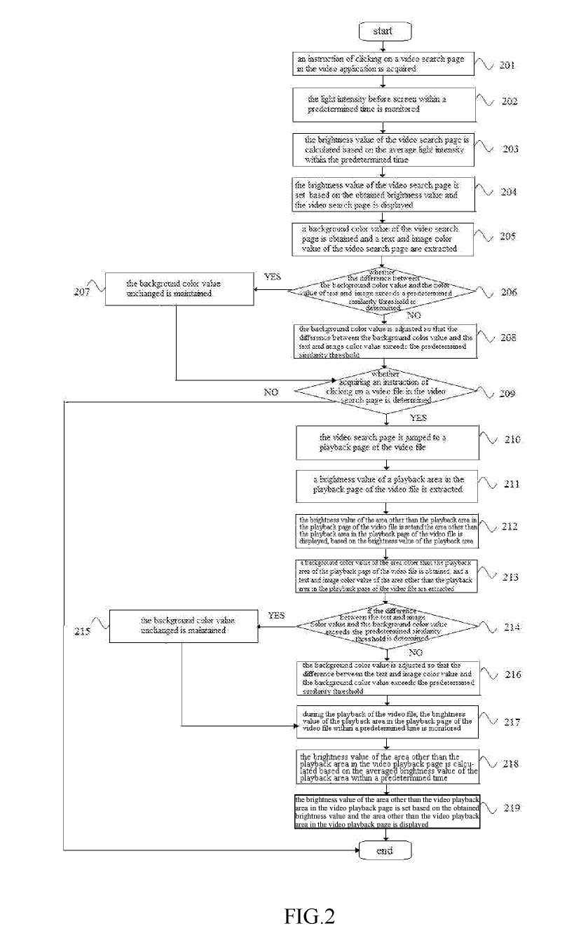

As a referable embodiment, see FIG. 2, the method for implementing a video application may include the following steps.

Instep 201, an instruction of clicking on a video search page in the video application is acquired.

Instep 202, the light intensity before screen within a predetermined time is monitored.

Instep 203, the brightness value of the video search page is calculated based on the average light intensity within the predetermined time.

Instep 204, the brightness value of the video search page is set based on the obtained brightness value and the video search page is displayed.

Instep 205, a background color value of the video search page is obtained and a text and image color value of the video search page are extracted.

Instep 206, whether the difference between the background color value and the color value of text and image exceeds a predetermined similarity threshold is determined, if yes then executing step 207, or if no then executing step 208.

Instep 207, the background color value unchanged is maintained and step 209 is executed.

Instep 208, the background color value is adjusted so that the difference between the background color value and the text and image color value exceeds the predetermined similarity threshold, and step 209 is executed.

Instep 209, whether acquiring an instruction of clicking on a video file in the video search page is determined, if yes then executing step 210, or if no then exiting the flow.

Instep 210, the video search page is jumped to a playback page of the video file.

Instep 211, a brightness value of a playback area in the playback page of the video file is extracted.

Instep 212, the brightness value of the area other than the playback area in the playback page of the video file is set and the area other than the playback area in the playback page of the video file is displayed, based on the brightness value of the playback area.

Instep 213, a background color value of the area other than the playback area of the playback page of the video file is obtained, and a text and image color value of the area other than the playback area in the playback page of the video file are extracted.

Instep 214, if the difference between the text and image color value and the background color value exceeds the predetermined similarity threshold is determined, if yes then executing step 215, or if no then executing step 216.

Instep 215, the background color value unchanged is maintained and step 217 is executed.

Instep 216, the background color value is adjusted so that the difference between the text and image color value and the background color value exceeds the predetermined similarity threshold, and step 217 is executed.

Instep 217, during the playback of the video file, the brightness value of the playback area in the playback page of the video file within a predetermined time is monitored;

Instep 218, the brightness value of the area other than the playback area in the video playback page is calculated based on the averaged brightness value of the playback area within a predetermined time.

Instep 219, the brightness value of the area other than the video playback area in the video playback page is set based on the obtained brightness value and the video search page is displayed.

As a further referable embodiment, during the execution of steps 201-209, the method includes: monitoring the light intensity before screen, if the detected light intensity at a moment is lower than the predetermined minimum intensity threshold, then starting a screen saver. The method further includes: determining whether there is an operation to a terminal device, if yes then turning off the screen saver; if no then continuing the screen saver.

Furthermore, during the execution of steps 210-219, the method also includes: monitoring the light intensity before screen; if the detected light intensity at a moment is lower than the predetermined minimum intensity threshold, then pausing the current-playing video file and starting the screen saver. The method further includes: determining whether there is an operation to the terminal device, if there is an operation to a terminal device, then closing the screen saver; if there is no operation to a terminal device, then continuing the screen saver.

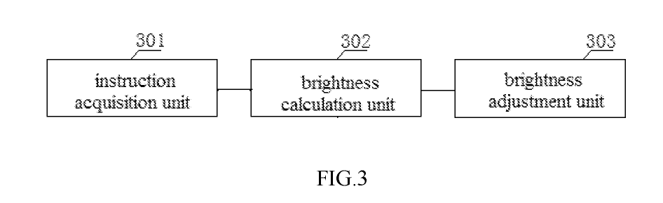

In another aspect of the embodiments of the present disclosure, there is provided an apparatus for implementing a video application, as shown in FIG. 3. The apparatus includes an instruction acquisition unit 301 configured to acquire an instruction of clicking on a video search page in a video application; a brightness calculation unit 302 configured to monitor the light intensity before the screen within a predetermined time and calculate the brightness value of the video search page based on the average light intensity within the predetermined time; and a brightness adjustment unit 303 configured to set the brightness value of the video search page based on the calculated brightness value and display the video search page.

As another embodiment of the present disclosure, because it will be occurred that the text and images in the video search page become unclear after adjustment of the brightness value of the video search page, the brightness adjustment unit 303 is further configured to obtain a background color value of the video search page and extract a text and image color value of the video search page after setting the brightness value of the video search page and displaying the video search page; and then determine whether the similarity between the text and image color value and the background color value exceeds a predetermined similarity threshold, if yes then maintain the background color value unchanged; if no then adjust the background color value so that the text and image color value and the background color value exceeds a predetermined similarity threshold.

Alternatively, the brightness adjustment unit 303 is further configured to monitor the light intensity before screen during the search action in the video search page; if the detected light intensity at a moment is lower than the predetermined minimum intensity threshold, then pause the current-playing video file and start a screen saver; and determine whether there is an operation to a terminal device, then close the screen saver if there is an operation to a terminal device; or continue the screen saver if there is no operation to a terminal device. As can be seen, this embodiment can ensure the hidden of the video playback page and protect the privacy of the viewer when he/she deliberately obscures the screen and does not want others to know the contents of the screen.

As another embodiment of the present disclosure, the brightness adjustment unit 303 is further configured to acquire an instruction of clicking on a video file in the video search page, and jump to a playback page of the video file; extract a brightness value of the playback area in the playback page of the video file; set the brightness value of the area other than the playback area in the playback page of the video file and display the area other than the playback area in the playback page of the video file, based on the brightness value of the playback area. That is, the brightness of the area other than the playback area in the video playback page can be set as the same as the brightness value of the playback area.

Alternatively, the brightness adjustment unit 303 is further configured to monitor the brightness value of the playback area in the playback page of the video file within a predetermined time during the playback of the video file; calculate the brightness value of the area other than the playback area in the playback page of the video file, based on the average brightness value of the playback area within the predetermined time; and set the brightness value of the area other than the playback area in the playback page of the video file and display the area other than the playback area in the playback page of the video file, based on the brightness value obtained by calculation.

That is, during the playback of the video file in the video playback page, the brightness value of the area other than the playback area can be dynamically adjusted based on the brightness value of the playback area, so as to keep the brightness value of the playback area consistent with that of the area other than the playback area. Therefore, such embodiment cannot only ensure to protect the viewer from the glare and unclear when watching video, but also effectively protect the viewer's eyes and improve his comfort during the viewer watches video in the video playback page, because the brightness value of the area other than the playback area always is dynamically kept consistent with the brightness value of the playback area.

Furthermore, the brightness adjustment unit 303 is further configured to obtain a background color value of the area other than the playback area of the playback page of the video file, and extract a text and image color value of the area other than the playback area in the playback page of the video file; determine if the difference between the text and image color value and the background color value exceeds the predetermined similarity threshold, if yes then maintain the background color value unchanged; if no then adjust the background color value so that the difference between the text and image color value and the background color value exceeds the predetermined similarity threshold. Thus, it makes the text and images of the area other than the video playback page also can be watched very clearly after adjusting the brightness value of the area other than the playback area in the video playback area.

It should be noted that, as an alternative embodiment of the present disclosure, the brightness adjustment unit 303 is further configured to monitor the light intensity before the screen during the playback of the video file; if the detected light intensity at one moment is lower than the predetermined minimum intensity threshold, then pause the current-playing video file and start a screen saver; determine whether there is an operation to a terminal device, then close the screen saver and play the paused video file if there is an operation to a terminal device; or continue the screen saver if there is no operation to a terminal device.

It should be understood that, the apparatus for implementing a video application described in the disclosure can be applied in mobile phone, PC, TV and other terminal devices. The apparatus for implementing a video application in the present disclosure has been described in detail in the discussion of the method for implementing a video application hereinbefore, so it is no longer to repeat the description.

In summary, the present disclosure provides methods and apparatus for implementing a video application, which creatively overcome the problem of the dazzling and unclear feeling to the viewer when searching in a video search page; and achieve the variety of services in a video application, so that the video application services can be more targeted and personalized. At the same time, it can ensure the user's privacy of users to a great extent and more secure. Finally, all the method and apparatus for implementing a video application are simple, compact and easy to implement.

In a further another aspect of an embodiment of the present disclosure, there is provided an device. As an embodiment of the device, the device includes one or more processor(s); and

a memory for storing operating instruction;

wherein the one or more processor(s) is/are configured to acquire the operation instruction from the memory to execute:

acquiring an instruction of clicking on a video search page in the video application;

monitoring the light intensity before screen within a predetermined time, and calculating the brightness value of the video search page based on the average light intensity within the predetermined time; and

setting the brightness value of the video search page based on the obtained brightness value and displaying the video search page.

Alternatively, the processors are configured to perform:

after setting the brightness value of the video search page and displaying the video search page:

obtaining a background color value of the video search page and extracting a text and image color value of the video search page; and

determining whether the difference between the text and image color value and the background color value exceeds a predetermined similarity threshold, and according to the result of the determination, maintaining the background color value unchanged or adjusting the background color value so that the text and image color value and the background color value exceeds the predetermined similarity threshold.

Alternatively, the processors are configured to perform:

after setting the brightness value of the video search page and displaying the video search page, acquiring an instruction of clicking on a video file in the video search page, and jumping to a playback page of the video file;

extracting a brightness value of the playback area in the playback page of the video file; and

setting the brightness value of the area other than the playback area in the playback page of the video file and displaying the area other than the playback area in the playback page of the video file, based on the brightness value of the playback area.

Alternatively, the processors are configured to perform:

during the playback of the video file, monitoring the brightness value of the playback area in the playback page of the video file within a predetermined time, and calculating the brightness value of the area other than the playback area in the playback page of the video file, based on the average brightness value of the playback area within the predetermined time; and

setting the brightness value of the area other than the playback area in the playback page of the video file and displaying the area other than the playback area in the playback page of the video file, based on the brightness value obtained by the calculation.

Alternatively, the processors are configured to perform:

after setting the brightness value of the area other than the playback area in the playback page of the video file and displaying the area other than the playback area in the playback page of the video file,

obtaining a background color value of the area other than the playback area of the playback page of the video file, and extracting a text and image color value of the area other than the playback area in the playback page of the video file;

determining if the difference between the text and image color value and the background color value exceeds the predetermined similarity threshold, and based on the result of the determination, maintaining the background color value unchanged or adjusting the background color value so that the difference between the text and image color value and the background color value exceeds the predetermined similarity threshold.

Alternatively, the processors are configured to perform:

during the playback of the video file, monitoring the light intensity before screen;

if the detected light intensity at a moment is lower than the predetermined minimum intensity threshold, then pausing the current-playing video file and starting a screen saver;

determining whether there is an operation to a terminal device, then closing the screen saver and playing the paused video file if there is an operation to a terminal device; or continuing the screen saver if there is no operation to a terminal device;

or when searching in the video search page, monitoring the light intensity before the screen;

if the detected light intensity at a moment is lower than the predetermined minimum intensity threshold, then starting the screen saver;

determining whether there is an operation to the terminal device, then closing the screen saver if there is an operation to the terminal device; or continuing the screen saver if there is no operation to the terminal device.

In a further another aspect of an embodiment of the present disclosure, there is provided a non-transitory computer-readable storage medium storing executable instructions that, when executed by an electronic device, cause the electronic device to:

acquire an instruction of clicking on a video search page in the video application;

monitor the light intensity before screen within a predetermined time and calculate the brightness value of the video search page based on the average light intensity within the predetermined time; and

set the brightness value of the video search page based on the obtained brightness value and displaying the video search page.

Alternatively, after setting the brightness value of the video search page and displaying the video search page, the execution of the instructions further causes the electronic device to:

obtain a background color value of the video search page and extract a text and image color value of the video search page; and

determine whether the difference between the text and image color value and the background color value exceeds a predetermined similarity threshold, and according to the result of the determination, maintain the background color value unchanged or adjust the background color value so that the text and image color value and the background color value exceeds the predetermined similarity threshold.

Alternatively, after setting the brightness value of the video search page and displaying the video search page, the execution of the instructions further causes the electronic device to:

acquire an instruction of clicking on a video file in the video search page, and jump to a playback page of the video file;

extract a brightness value of the playback area in the playback page of the video file; and

set the brightness value of the area other than the playback area in the playback page of the video file and display the area other than the playback area in the playback page of the video file, based on the brightness value of the playback area.

Alternatively, the execution of the instructions further causes the electronic device to:

during the playback of the video file, monitor the brightness value of the playback area in the playback page of the video file within a predetermined time, and calculate the brightness value of the area other than the playback area in the playback page of the video file, based on the average brightness value of the playback area within the predetermined time; and

set the brightness value of the area other than the playback area in the playback page of the video file and display the area other than the playback area in the playback page of the video file, based on the brightness value obtained by the calculation.

Alternatively, after setting the brightness value of the area other than the playback area in the playback page of the video file and displaying the area other than the playback area in the playback page of the video file, the execution of the instructions further causes the electronic device to:

obtain a background color value of the area other than the playback area of the playback page of the video file, and extract a text and image color value of the area other than the playback area in the playback page of the video file;

determine whether the difference between the text and image color value and the background color value exceeds the predetermined similarity threshold, and based on the result of the determination, maintain the background color value unchanged or adjust the background color value so that the difference between the text and image color value and the background color value exceeds the predetermined similarity threshold.

Alternatively, the execution of the instructions further causes the electronic device to:

during the playback of the video file, monitor the light intensity before screen;

if the detected light intensity at a moment is lower than the predetermined minimum intensity threshold, then pause the current-playing video file and to starting a screen saver;

determine whether there is an operation to a terminal device, then close the screen saver and play the paused video file if there is an operation to a terminal device; or continue the screen saver if there is no operation to a terminal device;

or when searching in the video search page, monitor the light intensity before the screen;

if the detected light intensity at a moment is lower than the predetermined minimum intensity threshold, then start the screen saver;

determine whether there is an operation to the terminal device, then close the screen saver if there is an operation to the terminal device; or continue the screen saver if there is no operation to the terminal device.

In addition, typically, the apparatus or terminal device of the present disclosure can be a variety of electronic terminal devices such as mobile phone, personal digital assistant (PDA), tablet PC (PAD), smart TV, etc., so that the scope of the disclosure should not be limited to a specific type of apparatus or terminal device.

Furthermore, the method according to the present disclosure may also be implemented as a computer program executed by CPU, and the computer program may be stored in a computer-readable storage medium. When the computer program is executed by CPU, the above functions defined in the methods of the present disclosure are executed.

Furthermore, the above-described method steps and apparatus units can also be implemented by using a controller and a computer-readable storage medium for storing a computer program to make the controller to achieve the above steps or unit functions.

Additionally, it should be appreciated that the computer-readable storage medium as described herein (for example, memory) may be volatile memory or nonvolatile memory, or can include both volatile memory and nonvolatile memory. As an example without any limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM) which can act as external cache RAM memory. As a example without any limitation, RAM is available in many forms, such as synchronous RAM (DRAM), dynamic RAM (DRAM), synchronous DRAM (SDRAM), double data rate SDRAM (DDR SDRAM), enhanced SDRAM (ESDRAM), sync link DRAM (SLDRAM) and direct RambusRAM (DRRAM). The disclosed aspects of the storage devices are intended to include, but not limited to these and other suitable types of memory.

Those skilled in the art will also understand that a combination of the illustrative logical blocks, modules, circuits, and algorithm steps described in this disclosure may be implemented as electronic hardware, computer software, or both. To clearly illustrate the interchangeability between hardware and software, various illustrative components, blocks, modules, circuits, and functions of steps have been generally described. Whether such function is implemented as software or hardware is depended on the particular application and the design constraints imposed on the whole system. Those skilled in the art can achieve the functions for each particular application in various ways, but such implementing decisions should not be interpreted as a departure from the scope of the present disclosure.

A combination of the illustrative logical blocks, modules, and circuits can be implemented or executed by using the following components designed to perform the functions described herein: general purpose processor (GPP), digital signal processor (DSP), dedicated integrated circuit (ASIC), field programmable gate array (FPGA) or other programmable logic device, discrete gate or transistor logic, discrete hardware components or any combination thereof. The GPP may be a microprocessor, but in the alternative, the processor may be any conventional processor, controller, microcontroller, or state machine. The processor may also be implemented as a combination of computing devices, e.g., a combination of DSP and microprocessor, a plurality of microprocessors, one or more microprocessors with a DSP core, or any other such configuration.

A combination of the steps of method or algorithm described herein may be contained directly in hardware, software module executed by a processor, or both. The software module may reside in RAM memory, flash memory, ROM memory, EPROM memory, EEPROM memory, registers, hard disk, removable disk, CD-ROM known in the art or any other form of storage medium. An exemplary storage medium is coupled to the processor such that the processor can read information from the storage medium or write information to the storage medium. Alternatively, the storage medium may be integrated into the processor. The processor and the storage medium may reside in ASIC. ASIC may reside in a user terminal. In one alternative, the processor and the storage medium may reside as discrete components in a user terminal.

In one or more exemplary designs, the functions described herein may be implemented in hardware, software, firmware, or any combination thereof. If implemented in software, the functions may be transmitted as one or more instructions or codes stored on a computer readable medium or by a computer-readable medium. Computer-readable medium includes both computer storage medium and communication medium, and the communication medium includes any medium contributed to transmit a computer program from one place to another. The storage medium may be any available medium accessible by a general purpose or special purpose computer. As an example without any restriction, the computer-readable medium can include RAM, ROM, EEPROM, CD-ROM or other optical disk storage, magnetic disk storage or other magnetic storage devices, or can be any other medium for carrying or storing the desired program codes in the form of instruction or data structures and can be accessed by or via a general purpose or special purpose computer. Also, any connection can be properly termed as a computer-readable medium. For example, if using a coaxial cable, fiber optic cable, twisted pair, digital subscriber line (DSL) or wireless technologies such as infrared, radio, and microwave to transmit software from website, server, or other remote source, the coaxial cable, fiber optic cable, twisted pair, DSL, or wireless technologies such as infrared, radio, and microwave are included in the definition of medium. As used herein, the terms of disk and disc include CD-ROM disc (CD), laser disc, optical disc, digital versatile disc (DVD), floppy disk and blue-ray disc where the disk usually reproduces data magnetically and the disc reproduces data optically with lasers. Combinations of the above should also be included within the scope of computer-readable medium.

It should be understood that various changes and modifications may be made to the exemplary embodiments disclosed herein, without departing from the scopes of the disclosure defined in the appended claims. The functions, steps and/or actions of the method claims disclosed herein do not have to be executed in any particular order. Furthermore, although elements of the present disclosure may be described or claimed as an individual form, but a plurality can also be envisaged unless explicitly restricted to single.

It should be understood that, as used herein, unless the context clearly supports exceptions, the singular forms “a” (“a”, “an”, “the”) is intended to include the plural forms. It should also be understood that “and/or” used herein is intended to include any and all possible combinations of one or more of the associated listed items.

The serial number of the embodiments herein is merely used for illustration without representing the merits of the embodiments.

Those ordinary skilled in the art will appreciate that all or part of the steps to achieve the above-described embodiments may be accomplished by hardware or by instructing relevant hardware via program, and the program may be stored in a computer readable storage medium such as read-only memory, magnetic disk or optical disc.

Those ordinary skilled in the art will appreciate that any of the embodiments discussed are exemplary only without intended to imply that the scopes of the present disclosure (including claims) are limited to these examples; the embodiments or the features in the different embodiments may be combined and the steps may be implemented in any order in accordance with the idea of the present disclosure, and there are many other variations of the different aspects of the present disclosure as described herein without description in the details for simplicity. Thus, any omissions, modifications, equivalent replacements and improvements made in the spirit and principles of the present disclosure should be included within the scopes of the present disclosure.

What is claimed is:

1. A method for implementing a video application, comprising:
at an electronic device:
acquiring an instruction of clicking on a video search page in the video application;
monitoring the light intensity before screen within a predetermined time and calculating the brightness value of the video search page based on the average light intensity within the predetermined time; and
setting the brightness value of the video search page based on the obtained brightness value and displaying the video search page.

2. The method according to claim 1, wherein after setting the brightness value of the video search page and displaying the video search page, the method further comprises:
acquiring an instruction of clicking on a video file in the video search page, and jumping to a playback page of the video file;
extracting a brightness value of a playback area in the playback page of the video file; and
setting the brightness value of the area other than the playback area in the playback page of the video file and displaying the area other than the playback area in the playback page of the video file, based on the brightness value of the playback area.

3. The method according to claim 1, wherein after setting the brightness value of the video search page and displaying the video search page, the method further comprises:
obtaining a background color value of the video search page and extracting a text and image color value of the video search page; and
determining whether the difference between the text and image color value and the background color value exceeds a predetermined similarity threshold; in accordance with the result of the determination, maintaining the background color value unchanged or adjusting the background color value so that the difference between the text and image color value and the background color value exceeds the predetermined similarity threshold.

4. The method according to claim 3, wherein after setting the brightness value of the video search page and displaying the video search page, the method further comprises:
acquiring an instruction of clicking on a video file in the video search page, and jumping to a playback page of the video file;
extracting a brightness value of a playback area in the playback page of the video file; and
setting the brightness value of the area other than the playback area in the playback page of the video file and displaying the area other than the playback area in the playback page of the video file, based on the brightness value of the playback area.

5. The method according to claim 4, further comprising:
during the playback of the video file, monitoring the brightness value of the playback area in the playback page of the video file within a predetermined time; calculating the brightness value of the area other than the playback area in the playback page of the video file, based on the average brightness value of the playback area within the predetermined time; and
setting the brightness value of the area other than the playback area in the playback page of the video file and displaying the area other than the playback area in the playback page of the video file, based on the brightness value obtained by the calculation.

6. The method according to claim 5, wherein after setting the brightness value of the area other than the playback area in the playback page of the video file and displaying the area other than the playback area in the playback page of the video file, the method further comprises:
obtaining a background color value of the area other than the playback area of the playback page of the video file, and extracting a text and image color value of the area other than the playback area in the playback page of the video file;
determining whether the difference between the text and image color value and the background color value exceeds the predetermined similarity threshold; and based on the result of the determination, maintaining the background color value unchanged or adjusting the background color value so that the difference between the text and image color value and the background color value exceeds the predetermined similarity threshold.

7. The method according to claim 5, wherein the method further comprises:
during the playback of the video file, monitoring the light intensity before screen;
if the detected light intensity at a moment is lower than the predetermined minimum intensity threshold, then pausing the current-playing video file and starting a screen saver;
determining whether there is an operation to a terminal device, then closing the screen saver and playing the paused video file if there is an operation to a terminal device; or continuing the screen saver if there is no operation to a terminal device;
or
when searching in the video search page, monitoring the light intensity before the screen;
if the detected light intensity at a moment is lower than the predetermined minimum intensity threshold, then starting the screen saver;
determining whether there is an operation to the terminal device, then closing the screen saver if there is an operation to the terminal device, or continuing the screen saver if there is no operation to the terminal device.

8. An electronic device, comprising:
at least one processor; and
a memory communicably connected with the at least one processor and for storing instructions executable by the at least one processor,
wherein execution of the instructions by the at least one processor causes the at least one processor to:
acquire an instruction of clicking on a video search page in the video application;
monitor the light intensity before screen within a predetermined time, and calculating the brightness value of the video search page based on the average light intensity within the predetermined time; and
set the brightness value of the video search page based on the obtained brightness value and display the video search page.

9. The electronic device according to claim 8, wherein after setting the brightness value of the video search page and displaying the video search page, the execution of the instructions causes the at least one processor further to:
acquire an instruction of clicking on a video file in the video search page, and jump to a playback page of the video file;
extract a brightness value of the playback area in the playback page of the video file; and
set the brightness value of the area other than the playback area in the playback page of the video file and display the area other than the playback area in the playback page of the video file, based on the brightness value of the playback area.

10. The electronic device according to claim 8, wherein after setting the brightness value of the video search page and displaying the video search page, the execution of the instructions causes the at least one processor further to:
obtain a background color value of the video search page and extract a text and image color value of the video search page; and
determine whether the difference between the text and image color value and the background color value exceeds a predetermined similarity threshold, and according to the result of the determination, maintain the background color value unchanged or adjust the background color value so that the text and image color value and the background color value exceeds the predetermined similarity threshold.

11. The electronic device according to claim 10, wherein after setting the brightness value of the video search page and displaying the video search page, the execution of the instructions causes the at least one processor further to:
acquire an instruction of clicking on a video file in the video search page, and jump to a playback page of the video file;
extract a brightness value of the playback area in the playback page of the video file; and
set the brightness value of the area other than the playback area in the playback page of the video file and display the area other than the playback area in the playback page of the video file, based on the brightness value of the playback area.

12. The electronic device according to claim 11, the execution of the instructions causes the at least one processor further to:
during the playback of the video file, monitor the brightness value of the playback area in the playback page of the video file within a predetermined time, and calculate the brightness value of the area other than the playback area in the playback page of the video file, based on the average brightness value of the playback area within the predetermined time; and
set the brightness value of the area other than the playback area in the playback page of the video file and display the area other than the playback area in the playback page of the video file, based on the brightness value obtained by the calculation.

13. The electronic device according to claim 12, wherein after setting the brightness value of the area other than the playback area in the playback page of the video file and displaying the area other than the playback area in the playback page of the video file, the execution of the instructions causes the at least one processor further to:
obtain a background color value of the area other than the playback area of the playback page of the video file, and extract a text and image color value of the area other than the playback area in the playback page of the video file;
determine whether the difference between the text and image color value and the background color value exceeds the predetermined similarity threshold, and based on the result of the determination, maintain the background color value unchanged or adjust the background color value so that the difference between the text and image color value and the background color value exceeds the predetermined similarity threshold.

14. The electronic device according to claim 12, the execution of the instructions causes the at least one processor further to:
during the playback of the video file, monitor the light intensity before screen;
if the detected light intensity at a moment is lower than the predetermined minimum intensity threshold, then pause the current-playing video file and start a screen saver;
determine whether there is an operation to a terminal device, then close the screen saver and play the paused video file if there is an operation to a terminal device; or continue the screen saver if there is no operation to a terminal device;
or
when searching in the video search page, monitor the light intensity before the screen;
if the detected light intensity at a moment is lower than the predetermined minimum intensity threshold, then start the screen saver;
determine whether there is an operation to the terminal device, then close the screen saver if there is an operation to the terminal device; or continue the screen saver if there is no operation to the terminal device.

15. A non-transitory computer-readable storage medium storing executable instructions that, when executed by an electronic device, cause the electronic device to:
acquire an instruction of clicking on a video search page in the video application;
monitor the light intensity before screen within a predetermined time and calculate the brightness value of the video search page based on the average light intensity within the predetermined time; and
set the brightness value of the video search page based on the obtained brightness value and display the video search page.

16. The non-transitory computer-readable storage medium according to claim 15, wherein after setting the brightness value of the video search page and displaying the video search page, the execution of the instructions further causes the electronic device to:
obtain a background color value of the video search page and extract a text and image color value of the video search page; and
determine whether the difference between the text and image color value and the background color value exceeds a predetermined similarity threshold, and according to the result of the determination, maintain the background color value unchanged or adjust the background color value so that the text and image color value and the background color value exceeds the predetermined similarity threshold.

17. The non-transitory computer-readable storage medium according to claim 15, wherein after setting the brightness value of the video search page and displaying the video search page, the execution of the instructions further causes the electronic device to:
acquire an instruction of clicking on a video file in the video search page, and jump to a playback page of the video file;
extract a brightness value of the playback area in the playback page of the video file; and
set the brightness value of the area other than the playback area in the playback page of the video file and display the area other than the playback area in the playback page of the video file, based on the brightness value of the playback area.

18. The non-transitory computer-readable storage medium according to claim 17, wherein the execution of the instructions further causes the electronic device to:
during the playback of the video file, monitor the brightness value of the playback area in the playback page of the video file within a predetermined time, and calculate the brightness value of the area other than the playback area in the playback page of the video file, based on the average brightness value of the playback area within the predetermined time; and
set the brightness value of the area other than the playback area in the playback page of the video file and display the area other than the playback area in the playback page of the video file, based on the brightness value obtained by the calculation.

19. The non-transitory computer-readable storage medium according to claim 18, wherein after setting the brightness value of the area other than the playback area in the playback page of the video file and displaying the area other than the playback area in the playback page of the video file, the execution of the instructions further causes the electronic device to:
obtain a background color value of the area other than the playback area of the playback page of the video file, and extract a text and image color value of the area other than the playback area in the playback page of the video file;
determine whether the difference between the text and image color value and the background color value exceeds the predetermined similarity threshold, and based on the result of the determination, maintain the background color value unchanged or adjust the background color value so that the difference between the text and image color value and the background color value exceeds the predetermined similarity threshold.

20. The non-transitory computer-readable storage medium according to claim 18, wherein the execution of the instructions further causes the electronic device to:
during the playback of the video file, monitor the light intensity before screen;
if the detected light intensity at a moment is lower than the predetermined minimum intensity threshold, then pause the current-playing video file and start a screen saver;
determining whether there is an operation to a terminal device, then close the screen saver and play the paused video file if there is an operation to a terminal device; or continue the screen saver if there is no operation to a terminal device;
or
when searching in the video search page, monitor the light intensity before the screen;
if the detected light intensity at a moment is lower than the predetermined minimum intensity threshold, then start the screen saver;
determine whether there is an operation to the terminal device, then close the screen saver if there is an operation to the terminal device; or continue the screen saver if there is not an operation to the terminal device.
